(19) United States
(12) Patent Application Publication
(10) Pub. No.: US 2005/0078775 A1
(43) Pub. Date: Apr. 14, 2005

(54) Mitigating the impact of phase steps

(76) Inventors: Martin Hellmark, Lund (SE); Hans Stattin, Malmo (SE)

Correspondence Address: Ross T. Robinson, Esq.;Jenkens & Gilchrist, A Professional Corporation, 1445 Ross Avenue, Suite 3200, Dallas, TX, 75202-2799, US

(21) Appl. No.: 10/651,404

(22) Filed: Aug. 29, 2003

Related U.S. Application Data
(60) Provisional application No. 60/412,835, filed on Sep. 23, 2002.

(51) Int. Cl. H04L 27/08

(52) U.S. Cl. 375/345

(57) ABSTRACT

Method and system are disclosed for preventing phase steps in digital receivers and transmitters that have a controllable gain. The method and system of the invention reduces the number of gain changes by applying hysteresis to the gain control of the receiver or transmitter. For a receiver, the hysteresis is applied with respect to the signal level received at the detector/demodulator. For a transmitter, the hysteresis is applied with respect to the transmit signal level. The hysteresis limits how frequent the gain changes occur so that only signals with amplitudes that exceed or fall below predefined thresholds will trigger a gain adjustment. Small, incremental changes in signal amplitude that lie within the range of the hysteresis will not trigger a gain adjustment.

### CROSS-REFERENCE TO RELATED APPLICATION

This application for patent claims the benefit of priority from, and hereby incorporates by reference, U.S. Provisional Patent Application Ser. No. 60/412,835 entitled “Mitigate Impact of Phase Steps,” filed with the U.S. Patent and Trademark Office on Sep. 23, 2002.

### BACKGROUND OF THE INVENTION

1. Field of the Invention

The invention is related to mobile communication systems and, in particular, to a method and system for mitigating the impact of phase steps in digital radio receivers and transmitters.

2. Description of the Related Art

In digital radio receivers, it is necessary to correct the phase of the received signal during detection thereof. Phase correction involves rotating the received signal in the constellation diagram in order to compensate for the arbitrary phase change induced by the air interface. The process that distorts the signal in the air interface is known as the fading. There are basically two types of fading: fast and slow fading. Slow fading is primarily due to the changing distance from the transmitter to the receiver as a result of movement by the user. Fast fading is primarily due to the self interference within the signal itself as a result of the signal traveling different distances (i.e., multipath effect) before arriving at the receiver. When the signal arrives at the receiver, the superposition of the electromagnetic fields of the multipath components may cancel or add constructively, causing fast fading. The fading process for both slow and fast fading affects the phase and the amplitude of the signal.

In order to compensate for the phase change in the air interface, the receiver also receives a pilot signal in addition to the desired signal over the same air interface. Since the two signals travel over the same interface, they are subjected to the same fading process. The phase change in the air interface can then be calculated from the pilot signal and used to correct the phase of the desired unknown signal. Because the air interface changes constantly due to movement of the digital receiver or due to environmental changes, the phase change in the air interface needs to the kept updated. Therefore, in modern mobile communication systems, the pilot signal is transmitted either intermittently or continuously.

The fading process and the air interface also makes the amplitude of the signal fluctuate at the receiver antenna. If the amplitude fluctuations exceed or fall below the dynamic range of the receiver, overflow or underflow of the signal may occur. In order to keep the amplitude of the received signal within the dynamic range of the receiver, the gain amplification in the receiver may be adjusted prior to detection. This may be accomplished, for example, by implementing an automatic gain control (AGC) mechanism in the receiver. The AGC mechanism increases or decreases the amplitude of the signal to bring it within the dynamic range of the detector/demodulator. In this way the dynamic range of the receiver is extended. However, changing the gain of the receiver may also affect the phase of the signal. This is particularly likely to happen if the change of gain is large and the amplifier is an RF amplifier.

Ideally, the change of phase in the signal is not harmful, since the change occurs equally in both the pilot signal and the desired signal. The phase change, including the phase itself, is acquired from the pilot signal, and the phase is then corrected on the desired signal. A problem, however, is that the air interface bandwidth is limited and shared between the pilot signal and the desired signal. Hence, in order to maximize the bandwidth capacity for the desired signal, the bandwidth of the pilot signal is minimized. This often produces a pilot signal with low SNR (signal-noise ratio), requiring the phase correction derived from the pilot signal to be averaged. Or if the pilot signal is transmitted intermittently over the air interface, the intervals between transmissions are made as long as possible in order to maximize bandwidth capacity for the desired signal.

In order to achieve a sufficiently accurate phase correction, however, it is necessary to average the phase of the pilot signal over some predefined time interval. This can present a problem when the gain is changed as a step (i.e., in a very short amount of time). Each gain step results in an associated phase step that requires some time before the averaging of the pilot signal yields the proper phase correction. The desired signal will be distorted during this time.

The same problem occurs when the pilot signal is transmitted only intermittently. The phase correction can be calculated only when the pilot signal is available, but the gain step and its associated phase step may occur at any time. Thus, a gain step that occurs after a transmission of a set of pilot signals will produce a phase step that will not be corrected until the next transmission of pilot signals.

Digital radio transmitters are similarly affected. Along with the desired signal, there is a pilot signal transmitted either intermittently or continuously. The purpose of the pilot signal is the same as described above, namely, phase correction in the receiver. If there is a sudden phase step in the transmitter due to a change of gain (i.e., transmit power), the receiver may not be able to properly detect the phase of the pilot signal. Consequently, the desired signal may be distorted at the receiver.

One way to alleviate the above problems is to design the block, module, or circuit within the transmitter or receiver that has a controllable gain so that there is negligible or no phase change when the gain is changed. However, this is not always feasible and is particularly challenging if the block, module, or circuit is for an RF signal.

An alternative solution is to provide a receiver or transmitter that can handle the full dynamic range of the signal so that no gain change is needed. However, a receiver or transmitter that can handle a large dynamic range is more difficult to design due to limitations on size, cost, current consumption, and other constraints.

Accordingly, it would be desirable to provide a way to reduce the impact of phase steps by reducing the frequency of the phase steps so that they occur less often. More specifically, it would be desirable to provide a way to reduce the occurrences of the gain steps that result in the phase steps.

### SUMMARY OF THE INVENTION

Briefly, the present invention is directed to method and system for preventing phase steps in digital receivers and transmitters that have a controllable gain. The method and system of the invention reduces the number of gain changes by applying hysteresis to the gain control of the receiver or transmitter. For a receiver, the hysteresis is applied with respect to the signal level received at the detector/demodulator. For a transmitter, the hysteresis is applied with respect to the transmit signal level. The hysteresis limits how frequent the gain changes occur so that only signals with amplitudes that exceed or fall below predefined thresholds will trigger a gain adjustment. Small, incremental changes in signal amplitude that lie within the range of the hysteresis will not trigger a gain adjustment.

In general, in one aspect, the invention is directed to a method of minimizing the impact of phase steps in a digital receiver having a controllable gain and a detector/demodulator. The method comprises the steps of defining an upper hysteresis threshold and a lower hysteresis threshold in a dynamic range of the detector/demodulator. The method further comprises receiving a signal at the detector/demodulator, the signal having a plurality of fluctuations in an amplitude thereof. The gain of the digital receiver is reduced if the amplitude of the received signal is above the upper hysteresis threshold of the detector/demodulator, and the gain of the digital receiver is increased if the amplitude of the received signal is below the lower hysteresis threshold of the detector/demodulator.

In general, in another aspect, the invention is directed to a digital receiver having a controllable gain. The receiver comprises a detector/demodulator, a variable gain amplifier connected to the detector/demodulator, and a variable gain controller connected to the variable gain amplifier. The variable gain controller is configured to define an upper hysteresis threshold and a lower hysteresis threshold in a dynamic range of the detector/demodulator, and receive a signal at the detector/demodulator, the signal having a plurality of fluctuations in an amplitude thereof. The gain of the digital receiver is reduced if the amplitude of the received signal is above the upper hysteresis threshold of the detector/demodulator, and the gain of the digital receiver is increased if the amplitude of the received signal is below the lower hysteresis threshold of the detector/demodulator.

In general, in yet another aspect, the invention is directed to a method of minimizing the impact of phase steps in a digital transmitter having a controllable gain and a variable gain controller. The method comprises defining an upper hysteresis threshold and a lower hysteresis threshold in the variable gain controller, and receiving a transmit signal level at the variable gain controller, the transmit signal level having a plurality of fluctuations therein. The method further comprises reducing a gain of the digital transmitter if the transmit signal level is above the upper hysteresis threshold, and increasing the gain of the digital transmitter if the transmit signal level is below the lower hysteresis threshold.

In general, in still another aspect, the invention is directed to a digital transmitter having a controllable gain. The digital transmitter comprises an antenna, a variable gain amplifier connected to the antenna, and a variable gain controller connected to the variable gain amplifier. The variable gain controller is configured to define an upper hysteresis threshold and a lower hysteresis threshold in the variable gain controller, and receive a transmit signal level at the variable gain controller, the transmit signal level having a plurality of fluctuations therein. The gain of the digital transmitter is reduced if the transmit signal level is above the upper hysteresis threshold, and gain of the digital transmitter is increased if the transmit signal level is below the lower hysteresis threshold.

It should be emphasized that the term comprises/comprising, when used in this specification, is taken to specify the presence of stated features, integers, steps, or components, but does not preclude the presence or addition of one or more other features, integers, steps, components, or groups thereof:

### BRIEF DESCRIPTION OF THE DRAWINGS

A better understanding of the invention may be had by reference to the following detailed description when taken in conjunction with the accompanying drawings, wherein:

FIG. 1 is a functional block diagram of a prior art digital receiver;

FIG. 2 is graph representing a prior art gain control algorithm;

FIG. 3 functional block diagram of a digital receiver according to embodiments of the invention;

FIG. 4 is graph representing a gain control algorithm for a digital receiver according to embodiments of the invention;

FIG. 5 is a functional block diagram of a digital transmitter according to embodiments of the invention;

FIG. 6 is graph representing a gain control algorithm for a digital transmitter according to embodiments of the invention;

FIG. 7 is a flow diagram representing a gain control algorithm according to embodiments of the invention; and

FIG. 8 is a flow diagram representing another gain control algorithm according to embodiments of the invention.

### DETAILED DESCRIPTION OF THE INVENTION

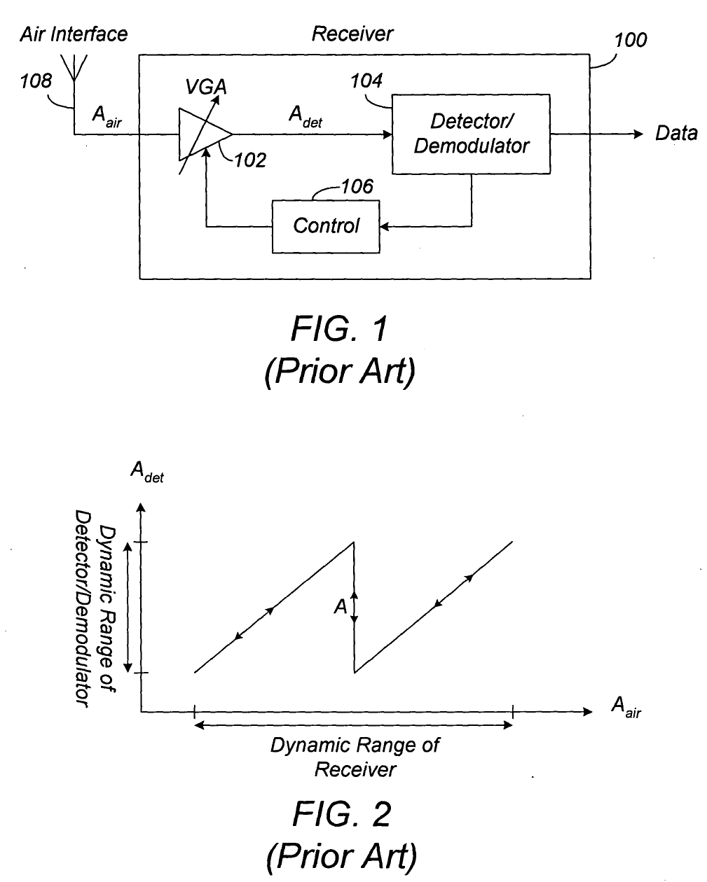

Following is a detailed description of the invention with reference to the drawings wherein reference numerals for the same or similar elements are carried forward. As mentioned previously, embodiments of the invention provide a method and system for reducing the frequency of gain steps in digital receivers and transmitters that have a controllable gain. Referring now to FIG. 1, a prior art digital receiver 100 is shown in functional block diagram form. The digital receiver 100 has a number of functional components therein, including a variable gain amplifier 102 (VGA), a signal detector/demodulator 104, and a variable gain controller 106, all connected as shown. An antenna 108 is connected to the VGA 102. These components are well known to those persons having ordinary skill in the radio communication art and will be described only briefly here.

In general, the antenna 108 receives the transmitted signal from the air interface and provides the signal to the VGA 102. The dynamic range of the amplitude of the signal that can be received at the antenna 108 is typically quite large (e.g., from about 80 dB to 120 dB). On the other hand, the dynamic range of the signal amplitude that can be received by the detector/demodulator 104 is typically smaller (e.g., from about 20 dB to 90 dB). Therefore, the VGA 102 is provided in order to adjust the amplitude of the signal received from the antenna 108 to within the dynamic range of the detector/demodulator 104. The amount of adjustment or gain provided by the VGA 102 is controlled by the variable gain controller 106. For example, if the amplitude of the signal received at the VGA 102 is above a certain predefined threshold, the variable gain controller 106 reduces the gain of the VGA 102 to thereby reduce the signal amplitude. If the amplitude of the signal received at the VGA 102 is below a certain predefined threshold, the variable gain controller 106 increases the gain of the VGA 102 to thereby increase the signal amplitude.

The above arrangement is shown graphically in FIG. 2, in which the horizontal axis (Aₐᵢᵣ) represents the signal amplitude at the antenna, the vertical axis (A_{det}) represents the signal amplitude at the detector/demodulator 104, and the line graph represents the signal received by the receiver 100. The dynamic range of the detector/demodulator 104 is indicated by the double-headed arrow along the vertical axis, and the dynamic range of the receiver (antenna) is indicated by the double-headed arrow along the horizontal axis.

As can be seen, the dynamic range of the detector/demodulator 104 is smaller than the dynamic range of the receiver. Thus, as the amplitude of the signal received at the detector/demodulator 104 rises (going left to right on the graph) beyond the upper limit of the dynamic range of the detector/demodulator 104, the gain of the VGA 102 is reduced by a certain predefined amount, indicated by the letter “A”. On the other hand, if the amplitude of the signal received at the detector/demodulator 104 falls (going right to left on the graph) below the lower limit of the dynamic range of the detector/demodulator 104, then the gain of the VGA 102 is increased by a certain predefined amount, indicated by the letter “A”. Note that each increase or decrease in the gain of the VGA 102 occurs in a single step.

The drawback of the above approach is that if there are multiple small fluctuations in the signal, then the variable gain controller 106 may bounce back and forth between increasing and decreasing the gain of the VGA 102. Since each adjustment to the gain of the VGA 102 occurs as a single step, an associated phase step will be induced in the signal with each gain step. For rapid fluctuations (such as those due to fast fading), the receiver may not be able to compensate for every phase step due to the time needed to average the phase of the pilot signal, thereby resulting in distortion of the signal. The problem is exacerbated where the pilot signal is transmitted only intermittently and the phase steps occur in between transmissions.

The present invention solves the above problem by implementing hysteresis in the variable gain controller of the receiver. The hysteresis prevents small fluctuations in the amplitude of the signal received at the detector/demodulator 104 from triggering adjustments to the gain of the VGA 102. Since the types of fluctuations that can trigger rapid and repeated adjustments to the gain of the VGA 102 typically have a relatively small dynamic range (such as those due to fast fading), the detector/demodulator 104 should not be too adversely affected, if at all, by their presence. Thus, only large fluctuations in the amplitude of the signal (such as those due to slow fading) will trigger an adjustment to the gain of the VGA 102. Since these fluctuations typically occur more slowly, the received signal will be distorted by the phase step less often.

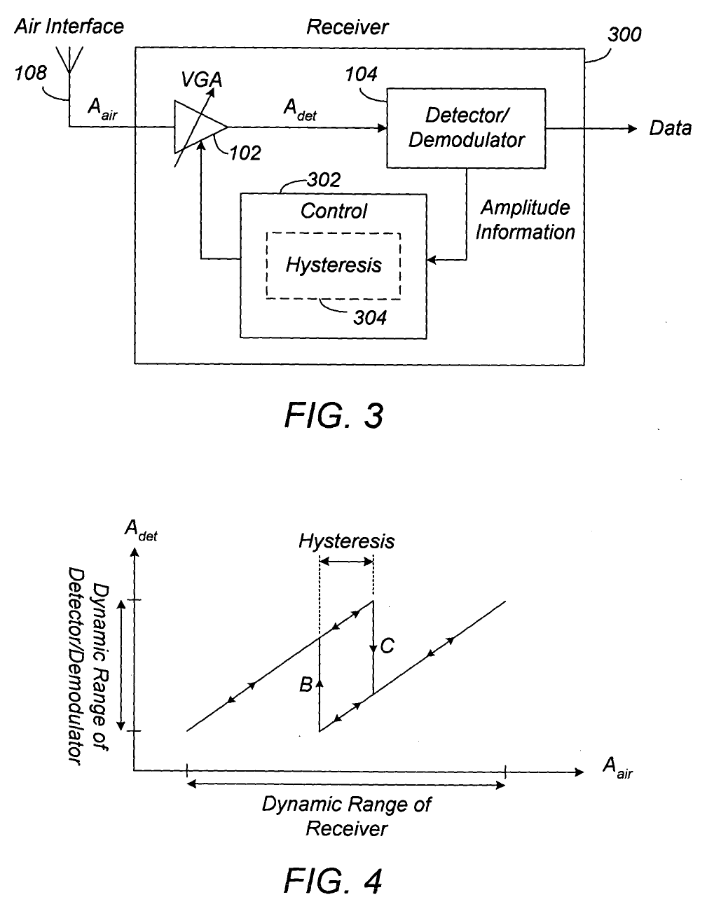

Referring now to FIG. 3, a digital receiver 300 according to embodiments of the invention is shown. Such a digital receiver 300 may be used in time-continuous mobile communication systems where sending and receiving take place on a continuous basis, such as the Universal Mobile Telecommunications System (UMTS), Code Division Multiple Access Systems (CDMA), and the like. The digital receiver 300 is similar to the digital receiver 100 shown in FIG. 1 in that it includes a VGA 102, a detector/demodulator 104, and an antenna 108. In addition, the digital receiver 300 includes a new and improved variable gain controller 302. The variable gain controller 302 receives the detected signal's amplitude information from the detector/demodulator 104 and uses this information to adjust (increase/decrease) the gain of the VGA 102 accordingly. In accordance with embodiments of the invention, the variable gain controller 302 has a hysteresis algorithm 304 implemented therein. The hysteresis algorithm 304 prevents small fluctuations in the amplitude of the signal detected at the detector/demodulator 104 (i.e., after the VGA 102) from triggering adjustments to the gain of the VGA 102.

A graphical illustration of the operation of the variable gain controller 302 in the receiver 300, and the hysteresis algorithm 304 therein, is shown in FIG. 4. The graph shown in FIG. 4 is similar to the graph shown in FIG. 2 in that the horizontal axis represents the signal amplitude at the antenna, the vertical axis represents the signal amplitude at the detector/demodulator 104, and the line graph represents the signal received by the receiver 300. The dynamic ranges are again shown by the double-headed arrows along both axes. In accordance with embodiments of the invention, the hysteresis algorithm 304 defines a lower threshold and an upper threshold below which and above which small fluctuations in the amplitude of the signal received at the detector/demodulator 104 will not trigger a gain change. The result is that a decrease in the gain of the VGA 102 occurs only when the amplitude of the signal received at the detector/demodulator 104 exceeds the upper hysteresis threshold. Likewise, an increase in the gain of the VGA 102 occurs only when the amplitude of the signal received at the detector/demodulator falls below the lower hysteresis threshold.

The upper and lower thresholds of the hysteresis may be selected as needed, but should be spaced far enough apart to prevent small fluctuations in the detected signal's amplitude from triggering a gain adjustment. Preferably, the upper and lower thresholds of the hysteresis correspond to the upper and lower limits of the dynamic range of the detector/demodulator. The amount of the gain increase and decrease, indicated by letters “B” and “C”, respectively, may be defined as needed, for example, “B” may be about equal to “C”. The relationship between the upper and lower thresholds of the hysteresis and the gain adjustments “B” and “C” may depend on the particular implementation of the digital receiver. In an ideal application, “B” is always equal to “C,” which is equal to the amount of gain change in the VGA 102. In general, the dynamic range of the detector/demodulator (or the modulator in a transmitter) and the desired dynamic range of the receiver (or the transmitter) determine the size of the hysteresis and of “B,” “C,” and the gain change in the VGA 102. For example, in one exemplary real world application, the hysteresis is about 12 dB and “B” equals “C,” which equals ˜25 dB of gain change in the VGA 102.

Note that although a digital receiver was described, the principles and teachings discussed herein may be equally applicable to digital transmitter. For example, in CDMA systems, such as IS-95 or UMTS (which is WCDMA), the transmit power from the mobile terminal transmitter is carefully controlled by the base station via control signals sent on the down link so that the signal level from the mobile terminal transmitter is always approximately constant at the base station. Since the up link signal from the mobile terminal transmitter is subject to fast fading, the base station will continuously command the mobile terminal transmitter to increase or decrease the transmit level in order to maintain an approximately constant signal level. Thus, to minimize the number of small, rapid fluctuations in the transmitted signal, hysteresis may be implemented in the mobile terminal transmitter.

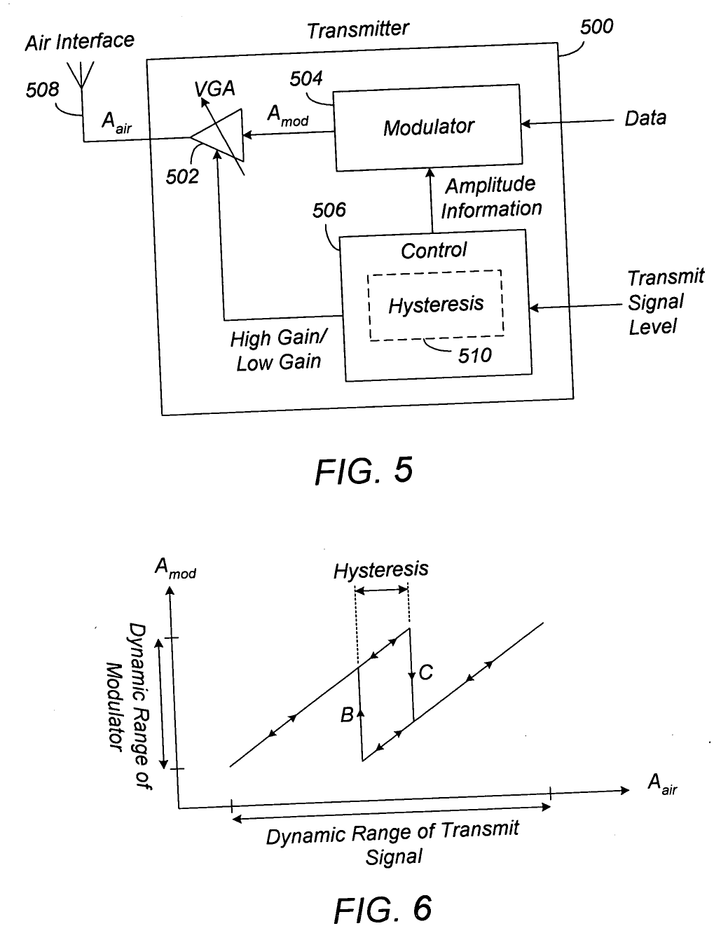

An exemplary implementation of a digital transmitter according to embodiments of the invention is shown in FIG. 5. As can be seen, the digital transmitter 500 has a number of functional components, including a VGA 502, a modulator 504, and a variable gain controller 506. An antenna 508 transmits the signal from the digital transmitter 500. In accordance with embodiments of the invention, the variable gain controller 506 has a hysteresis algorithm 510 implemented therein. The hysteresis algorithm 510 prevents small fluctuations in the transmit signal level from triggering adjustments to the gain of the VGA 502. Specifically, the hysteresis algorithm 510 defines a lower threshold and an upper threshold above which and below which small fluctuations in the transmit signal level will not trigger a gain change. The result is that a decrease in the gain of the VGA 502 occurs only when the transmit signal level exceeds the upper hysteresis threshold. Likewise, an increase in the gain of the VGA 502 occurs only when the transmit signal level falls below the lower hysteresis threshold.

A graphical illustration of the operation of the variable gain controller 506 in the transmitter 500, and the hysteresis algorithm 510 therein, is shown in FIG. 6. In FIG. 6, the vertical axis represents the signal amplitude at the modulator 504, and the line graph represents the signal transmitted by the transmitter 500. The horizontal axis represents the signal amplitude at the antenna, which is controlled or set by the transmit signal level. The dynamic ranges are again shown by the double-headed arrows along both axes. For an ideal transmitter, the transmit signal level and the signal amplitude at the antenna are exactly the same. Thus, effectively, the hysteresis limits in a transmitter are set with respect to the transmit signal level (horizontal axis), whereas they are set with respect to the amplitude of the signal at the detector (vertical axis) in a receiver.

In accordance with embodiments of the invention, the hysteresis algorithm 510 defines a lower threshold and an upper threshold below which and above which small fluctuations in the transmit signal level will not trigger a gain change. The result is that a decrease in the gain of the VGA 502 occurs only when the transmit signal level exceeds the upper hysteresis threshold. Likewise, an increase in the gain of the VGA 502 occurs only when the transmit signal level falls below the lower hysteresis threshold.

The hysteresis depends on the dynamic range of the modulator and the dynamic range of the transmitter. The hysteresis limits are set as an upper limit and as a lower limit on the transmit signal level going to the hysteresis block 510. In an exemplary implementation of the transmitter, the hysteresis is about 10 dB, and “B” equals “C,” which equals about 20 dB of gain change in the VGA 502.

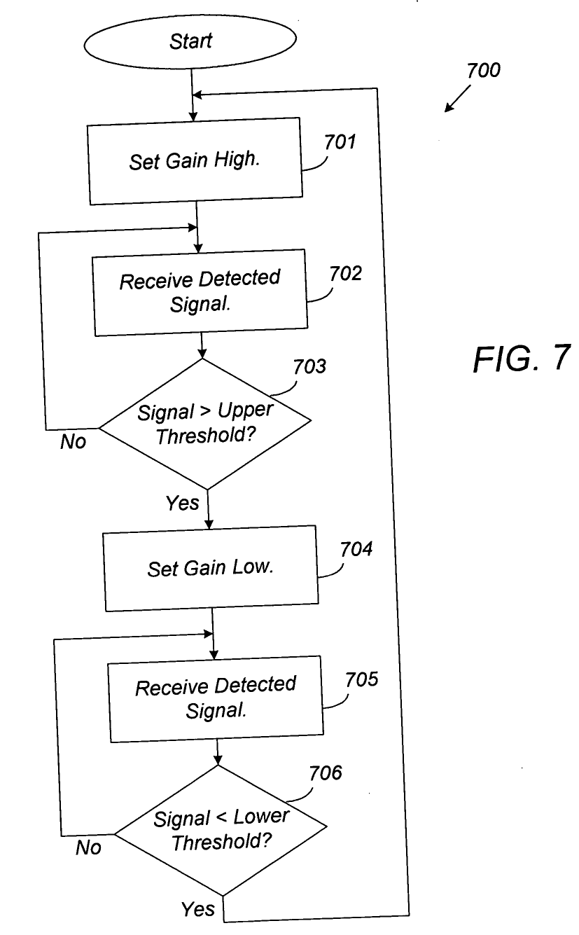

Referring now to FIG. 7, an exemplary method 700 of implementing hysteresis in a variable gain controller according to embodiments of the invention is shown. Although the method is described with respect to a number of discrete steps, it should be understood that two or more steps may be combined, or a single step may be divided into multiple steps. The method 700 begins at the first step 701, where the gain of the receiver is set to a high level by increasing the gain of the VGA. At the second step 702, a signal is detected and received at the variable gain controller. A determination is made at the third step 703 as to whether the signal amplitude is above a predefined upper threshold. If the answer is no, then the method 700 returns to the previous step 702 for further detecting and receiving of the next signal. If the answer is yes, then at the fourth step 704, the variable gain controller sets the gain low by decreasing the gain of the VGA. At the fifth step 705, another signal is detected and received at the variable gain controller. A determination is thereafter made at step 706 as to whether the signal amplitude is below a predefined lower threshold. If the answer is yes, then the method 700 returns to step 701 in order to reset the gain high by increasing the gain of the VGA. If the answer is no, then the method 700 returns to the previous step 705 for further processing.

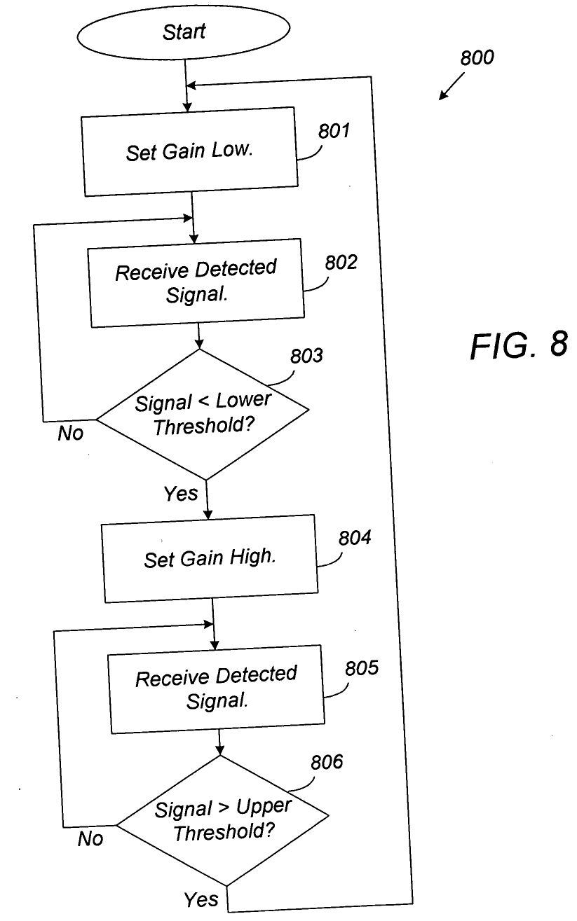

FIG. 8 illustrates another exemplary method 800 of implementing hysteresis in a variable gain controller. The method 800 of FIG. 8 is similar to the method 700 of FIG. 7 except that the sequence of setting the VGA gain high/low has been reversed.

The foregoing embodiments provide a system and method for reducing the number of gain steps, and thereby reducing the number of phase steps in a digital receiver with controllable gain. Thus, the impact of the phase steps in the digital receiver can be mitigated. As a result, distortion of the received signal in such digital receivers may be reduced. It should be emphasized that the principles and concepts described herein may be equally applicable to digital transmitters as well.

Thus, while particular embodiments and applications of the present invention have been illustrated and described, it is to be understood that the invention is not limited to the precise construction and compositions disclosed herein, and that modifications and variations may be made to the foregoing without departing from the scope of the invention as defined in the appended claims.

1. A method of minimizing the impact of phase steps in a digital receiver having a controllable gain and a detector/demodulator, comprising:
defining an upper hysteresis threshold and a lower hysteresis threshold in a dynamic range of the detector/demodulator;
receiving a signal at the detector/demodulator, the signal having a plurality of fluctuations in an amplitude thereof;
reducing a gain of the digital receiver if the amplitude of the received signal is above the upper hysteresis threshold of the detector/demodulator; and
increasing the gain of the digital receiver if the amplitude of the received signal is below the lower hysteresis threshold of the detector/demodulator.

2. The method according to claim 1, wherein the fluctuations in the signal are small, rapid fluctuations similar to those resulting from fast fading of the signal.

3. The method according to claim 1, wherein the gain reduction and the gain increase are substantially equal to each other.

4. The method according to claim 1, wherein the lower hysteresis threshold and the upper hysteresis threshold are selected so as to correspond to an upper limit and a lower limit, respectively, of the dynamic range of the detector/demodulator.

5. The method according to claim 1, wherein the digital receiver is capable of being used in a time-continuous mobile communication system.

6. The method according to claim 1, wherein the digital receiver is capable of being used in code division multiple access system.

7. A digital receiver having a controllable gain, comprising:
a detector/demodulator;
a variable gain amplifier connected to the detector/demodulator; and
a variable gain controller connected to the variable gain amplifier, the variable gain controller configured to:
define an upper hysteresis threshold and a lower hysteresis threshold in a dynamic range of the detector/demodulator;
receive a signal at the detector/demodulator, the signal having a plurality of fluctuations in an amplitude thereof;
reduce a gain of the digital receiver if the amplitude of the received signal is above the upper hysteresis threshold of the detector/demodulator; and
increase the gain of the digital receiver if the amplitude of the received signal is below the lower hysteresis threshold of the detector/demodulator.

8. The digital receiver according to claim 7, wherein the fluctuations in the signal are small, rapid fluctuations similar to those resulting from fast fading of the signal.

9. The digital receiver according to claim 7, wherein the gain reduction and the gain increase are substantially equal to each other.

10. The digital receiver according to claim 7, wherein lower hysteresis threshold and the upper hysteresis threshold are selected so as to correspond to an upper limit and a lower limit, respectively, of the dynamic range of the detector/demodulator.

11. The digital receiver according to claim 7, wherein the digital receiver is capable of being used in a time-continuous mobile communication system.

12. The digital receiver according to claim 7, wherein the digital receiver is capable of being used in a code division multiple access system.

13. A method of minimizing the impact of phase steps in a digital transmitter having a controllable gain and a variable gain controller, comprising:
defining an upper hysteresis threshold and a lower hysteresis threshold in the variable gain controller;
receiving a transmit signal level at the variable gain controller, the transmit signal level having a plurality of fluctuations therein;
reducing a gain of the digital transmitter if the transmit signal level is above the upper hysteresis threshold; and
increasing the gain of the digital transmitter if the transmit signal level is below the lower hysteresis threshold.

14. The method according to claim 13, wherein the fluctuations in the signal are small, rapid fluctuations similar to those resulting from fast fading of the signal.

15. The method according to claim 13, wherein the gain reduction and the gain increase are substantially equal to each other.

16. The method according to claim 13, wherein the lower hysteresis threshold and the upper hysteresis threshold are selected so as to correspond to the dynamic range of the modulator.

17. The method according to claim 13, wherein the digital transmitter is capable of being used in a time-continuous mobile communication system.

18. The method according to claim 13, wherein the digital transmitter is capable of being used in a code division multiple access system.

19. A digital transmitter having a controllable gain, comprising:
an antenna;
a variable gain amplifier connected to the antenna; and
a variable gain controller connected to the variable gain amplifier, the variable gain controller configured to:
define an upper hysteresis threshold and a lower hysteresis threshold in the variable gain controller;
receive a transmit signal level at the variable gain controller, the transmit signal level having a plurality of fluctuations therein;
reduce a gain of the digital transmitter if the transmit signal level is above the upper hysteresis threshold; and
increase the gain of the digital transmitter if the transmit signal level is below the lower hysteresis threshold.

20. The digital transmitter according to claim 19, wherein the fluctuations in the signal are small, rapid fluctuations similar to those resulting from fast fading of the signal.

21. The digital transmitter according to claim 19, wherein the gain reduction and the gain increase are substantially equal to each other.

22. The digital transmitter according to claim 19, wherein lower hysteresis threshold and the upper hysteresis threshold are selected so as to correspond to the dynamic range of the modulator.

23. The digital transmitter according to claim 19, wherein the digital transmitter is capable of being used in a time-continuous mobile communication system.

24. The digital transmitter according to claim 19, wherein the digital transmitter is capable of being used in a code division multiple access system.
